(19) United States
(12) Patent Application Publication
(10) Pub. No.: US 2009/0135256 A1
(43) Pub. Date: May 28, 2009

(54) SATA CAMERA SYSTEM

(75) Inventor: Katsumi Komori, Tokyo (JP)

Correspondence Address: KATTEN MUCHIN ROSENMAN LLP, 575 MADISON AVENUE, NEW YORK, NY, 10022-2585, US

(73) Assignee: ARTRAY CO., LTD, TOKYO (JP)

(21) Appl. No.: 12/089,976

(22) PCT Filed: Sep. 11, 2006
(86) PCT No.: PCT/JP2006/317970

§ 371 Date: Apr. 11, 2008

(30) Foreign Application Priority Data
Oct. 12, 2005 (JP) 2005-298189

(51) Int. Cl. H04N 5/225

(52) U.S. Cl. 348/207.1; 348/E05.024

(57) ABSTRACT

It is possible to provide a novel CCD camera capable of being connected to a PC, an HDD, or the like compatible with a host SATA by using a simple configuration. A SATA' camera system (10) includes a camera module (12) and a SATA camera interface (27) and can be directly connected to a computer (72) or a hard disc drive (74) compatible with SATA. The SATA camera interface (27) has at least an FPGA (28), an image memory (76), and a PATA-SATA converter (58). The FPGA performs conversion of a video signal when writing/reading a digital video signal from the camera module into/from the image memory (76). The PATA-SATA convert (58) converts the parallel type video signal into a serial type video signal which can be transmitted to the computer (72) or the hard disc drive (74) compatible with the SATA.

### TECHNICAL FIELD

The present invention relates to SATA (Serial ATA) camera system.

### BACKGROUND ARTS

A video camera which utilizes CCD image sensor has been known. In recent years, as the CCD image sensor has advanced to high-fine, the high-fine CCD camera more than 0.8 Mega pixels has been appeared on the market. Some of the high-fine cameras can output an image to a television or a personal computer (PC). Generally, a parallel output according to the standard such as the camera link interface or the LVDS (Low Voltage Differential Signaling) is used for outputting an image to the PC.

FIG. 1 shows, for example, the block diagram of a conventional computer output CCD camera (also referred to as “CCD video camera”) which uses the capture board (6) as the camera link interface. This CCD video camera comprises camera module (2) of an optical and signal processing system, FPGA 4 which processes a digital image signal from the camera module (2) and the capture board (6) which processes the image signal from FPGA for the host PC, to output the image signal to the host PC (7).

### DISCLOSURE OF INVENTION

### Problem to be Solved by the Invention

The capture board (6) is the dedicated device to connect the digital image signal from the camera module (2) to the host PC (7) and it has been mostly expensive.

On the other hand, a host controller of Serial ATA (also referred to as “SATA”) has mostly been equipped on a motherboard used for a recent PC. Further, almost HDD (Hard Disk Drive) makers have released a SATA compatible HDD on the market.

Furthermore, a host controller and HDD compatible to SATA II have been released since 2005, the transmission speed of which SATA II increases to 3.0 Gps from 1.5 Gps of the transmission speed of SATA I.

Under these circumstances, the development of CCD camera system that is simple structure and is possible to connect to the host PC and the SATA compatible HDD etc. has been desired.

Additionally, the development of CCD camera system that is possible to connect to the host PC and the SATA compatible HDD etc., without making a significant change to the host PC and the SATA compatible HDD and the structure of an existing CCD video camera system.

### Measure to Solve the Problem

Accordingly, it is an object of the present invention to provide a novel CCD camera capable of being connected to a host PC, an HDD, or the like compatible with a host SATA by using a simple configuration.

Further, it is another object of the present invention is to provide a novel camera system, without making a significant change to a host PC, an HDD, or the like compatible with a host SATA and the structure of existing CCD camera system.

In consideration of the above objects, a SATA camera system of the present invention comprises a camera module and a SATA camera interface, wherein the SATA camera system is able to directly connect to a SATA compatible PC or a hard disk drive.

Further, as to the SATA camera system, said SATA camera system may comprises a FPGA, an image memory, and a PATA-SATA converter, wherein said FPGA processes the conversion of a digital image signal from camera module during writing and loading to the image memory, said PATA-SATA converter converts the parallel image signal to a serial image signal to be able to send it to a SATA compatible PC or a HDD.

Further, as to the SATA camera system, said image memory may be SDRAM or DDR SDRAM.

Further, as to the SATA camera system, said FPGA may include a first converting circuit to convert digital image signal from said camera module to writable signal to image memory, and a second converting circuit convert to read image signal written to said image memory as parallel image signal.

Further, as to the SATA camera system, said camera system may work as a SATA host camera, and the SATA host camera can used a SATA compatible HDD as an external recording media without other computers.

Further, as to the SATA camera system, said SATA camera system may work as a SATA device camera, and it can use as an outputting recording media for a main PC.

Further, as to the SATA camera system, said SATA interface further may have a SATA-PATA converter, thereby serial image data may read from SATA compatible PC or HDD can be converted to parallel data to store to said image memory.

Further, SATA camera interface means of the present invention converts parallel image signal from camera module to serial image for connecting to a SATA compatible computer or HDD.

Further, as to the SATA camera interface means, the SATA camera interface means may comprise, at least, a FPGA, an image memory, and a PATA-SATA converter; wherein said FPGA processes the conversion of a digital image signal from camera module during writing and loading to the image memory, said PATA-SATA converter converts the parallel image signal to a serial image signal to be able to send it to a SATA compatible PC or a HDD.

Further, as to the SATA camera interface means, said FPGA may include a first converting circuit to convert digital image signal from said camera module to writable signal to image memory, and a second converting circuit convert to read image signal written to said image memory as parallel image signal.

Further, as to the SATA camera interface means, said SATA interface further may have a SATA-PATA converter, thereby serial image data read from SATA compatible PC or HDD can be converted to parallel data to store to said image memory.

Further, a method for processing image data by SATA camera system of the present invention comprises the following steps of, loading parallel imaging data from a camera module, writing loaded image data to a buffer memory one by one followed by data, loading image data from buffer memory followed by data and writing to image memory, loading parallel data from image memory, converting loaded parallel image data to serial image data by PATA-SATA converter, and transferring serial data to PC or HDD.

Further, a computer program of the present invention orders a PC to execute each steps of the method for processing image data by SATA camera system.

Further, a recording media of the present invention records therein the computer program.

### EFFECT OF THE INVENTION

Accordingly, the effect of the present invention is able to provide a novel CCD camera capable of being connected to a host PC, an HDD, or the like compatible with a host SATA by using a simple configuration.

Further, the effect of the present invention is able to provide a novel camera system, without making a significant change to a host PC, an HDD, or the like compatible with a host SATA and the structure of existing CCD camera system.

### BRIEF DESCRIPTION OF THE DRAWINGS

FIG. 1 is an example showing a prior art camera system.

FIG. 2 is a block diagram showing an example of SATA camera system.

FIG. 3 is a block diagram showing an example of the camera module part of SATA camera system of FIG. 2.

FIG. 4 is a block diagram showing an example of FPGA part of SATA camera system shown in FIG. 2.

FIG. 5 is a block diagram showing an example of the first conversion circuit of FPGA part shown in FIG. 4.

FIG. 6A is a block diagram showing an example of PATA-SATA convertor part of SATA camera system shown in FIG. 2.

FIG. 6B is a block diagram showing an example of SATA-PATA conversion circuit.

FIG. 7 is a flow chart showing the method for processing image data by CPU of FPGA when the SATA camera system works as a host camera.

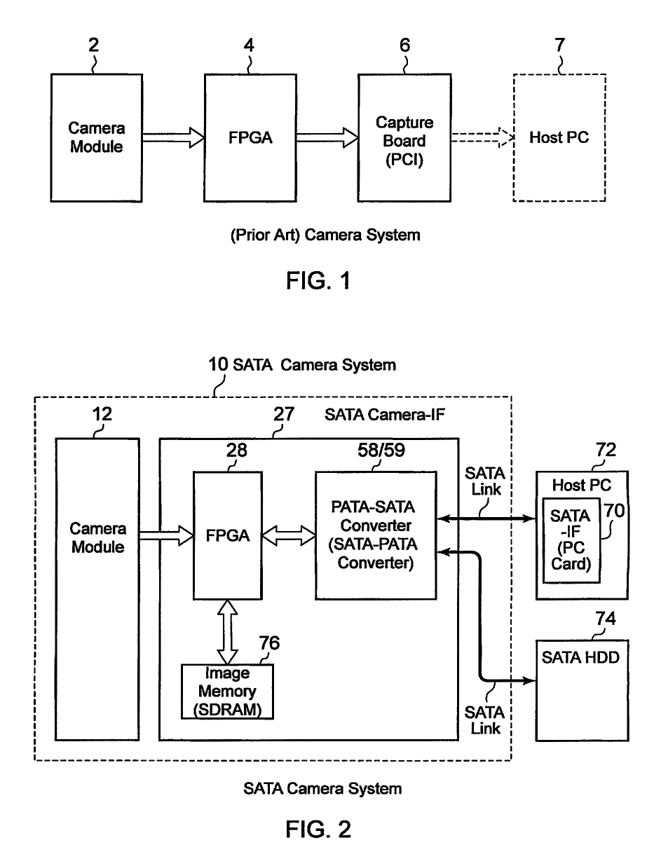

### DESCRIPTION OF REFERENCE NUMERAL

(2): Camera module, (4): FPGA, (6): Capturing board, (7): Host PC, (10): SATA camera system, (12): Camera module, (14): Image sensor, (16): PGA measure, (18): A-D conversion measure, (20): Color signal revision processing measure, (22): Color revision measure, (24): Camera control measure, (26): Host IF, (27): SATA interface, (28): FPGA, (29): CPU, (30): Camera controller IF, (31): Memory, (32): First conversion circuit, (34): Mode register section, Ring buffer section, (36): Write address control section, (38): Data write register, (40): Write memory bank control section, (42, 42-1, 42-2, 42-3, 424, 42-n): Ring buffer section, (48): Read memory bank section, (50): Data read register, (52): Memory controller IF, (54): 2^{nd} conversion circuit, (56): PATA controller IF, (58): PATA-SATA transmitter, IDE-SERIAL ATA transmitter, (60): Packet conversion measure, (62): CRC addition measure, (64): Scramble measure, (66): Encoder, (68): Parallel-serial measure, (70): SATA-IF (PC card), (72): Host PC, (74): SATA compatible HDD, (76): Picture memory (SDRAM, DDRSDRAM), (78): Serial-parallel measure, (80): Decoder, (82): Descramble measure, CRC check measure, (86): Packet divided measure

### DETAILED DESCRIPTION OF PREFERRED EMBODIMENTS

Embodiments of the present invention will now be described in detail with reference to the accompanying drawings. In order to avoid repetition, the same components shown in the accompanying drawings shall have the same reference numerals.

First of all, some terms of the interface used in this application document such as IDE, PATA, SATA, and serial ATA will be briefly explained to easily understand the present invention.

For example, parallel interface such as ATA (Advanced Technology Attachment) which is also referred to as SCSI (Small Computer System Interface) or IDE (Integrated Device Electronics) are mostly used for the high speed interface between a PC and a HDD.

However, the mechanism for avoiding the delay has been more expensive because the data has to be transmitted and received at the same time in the parallel interface.

Therefore, the serial interface which does not need the mechanism for avoiding delay is has became cheaper for the high speed interface. An interface as for ATA is changing from Parallel (Parallel ATA, also referred to as “PATA”) to Serial (Serial ATA, also referred to as “SATA”). Also, an interface as for SCSI is changing from Parallel to Serial (Serial Attached SCSI).

SATA becomes gradually widespread as a storage interface. The data transmission rate of the first standard SATA I is 150 M byte/s and that of the next standard SATA II is 300 M byte/s.

The present invention relates to a camera system which utilized the SATA interface.

### [SATA Camera System]

FIG. 2 is a block diagram showing an example of SATA camera system according to the embodiment of the present invention. This SATA camera system is, for example, capable of directly connecting to the host PC (72) which has the SATA interface (SATA-IF) (70) as the PC card (70) or to the SATA compatible HDD (SATA-HDD) (74) to transmit and receive continuously-streaming data which makes up a moving picture.

This SATA camera system (10) comprises the camera module (12) and the SATA camera interface (SATA camera-IF) (27) which processes the signal such as image signal (for example, RGB signal) from the camera module (12) to be able to connect it to the host PC (72) and the SATA-HDD (74).

This SATA camera-IF (27) has FPGA (Field Programmable Gate Array) (28) which converts the image signal from the camera module (12) to the signal capable of writing to the image memory (76) and also reads out as a parallel image signal the image signal which is written in image memory (76). Also, the SATA camera-IF (27) has PATA-SATA (Parallel ATA-Serial ATA) converter (58) which converts a parallel video signal from FPGA to the serial video signal. Also, the SATA camera-IF (27) creates the serial video signal which is able to send to the host PC (72) or the SATA-HDD (74).

### (Camera Module)

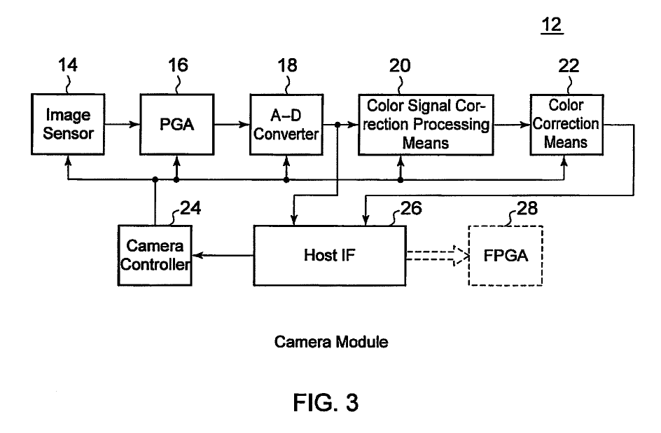

FIG. 3 is a block diagram showing an example of the camera module (12) of SATA camera system of FIG. 2. This camera module (12) includes an image sensor (14), a PGA (Programmable Gain Amplifier) (16), an A-D converter (18), a color signal correction processing means (20), a color correction means (22), a camera controller (24) which controls these means and a host interface (26) which transmits a color image signal to the FPGA (28) of the SATA IF (27).

The image sensor (14) is typically a CCD imaging device. Its lens mount may be C-mount or CS-mount etc. The CCD imaging device may be a frame sequential method of 1 CCD system or 3 CCD system, preferably a high resolution imaging device more than 0.8 Mega pixels.

The imaging signal which is taken by the CCD image sensor (14) is amplified by the PGA (16) according to the brightness of an object, and is converted to a digital signal by the A-D converter (18), and is processed for the interpolation of RGB with the color signal correction means (20), and then is processed for color correction by the matrix operation of RGB signal with the solor correction means (22) in order to improve the color reproducibility for white balance, and then is sent to the host interface (26). These means each are controlled by the camera controller (24) which consists of a suitable CPU.

### (FPGA)

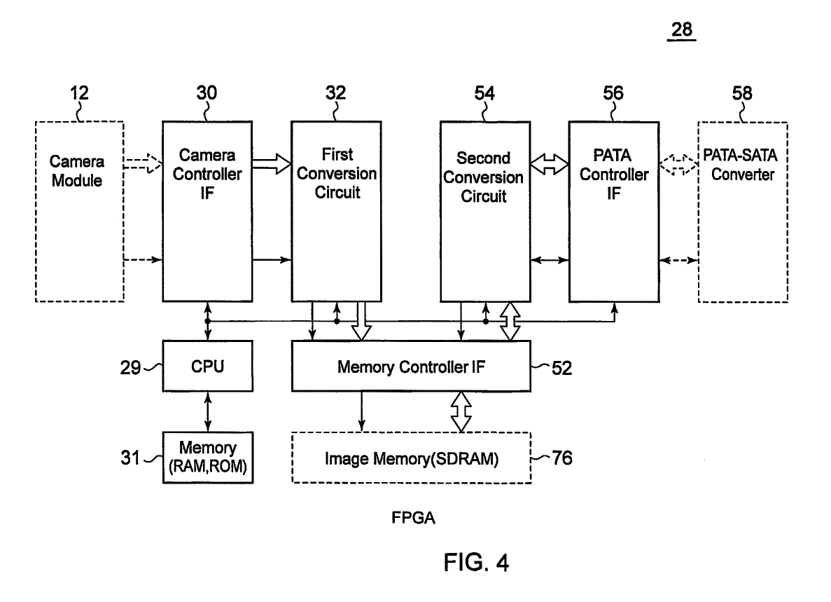

FIG. 4 is a block diagram showing an example of FPGA part of SATA camera system shown in FIG. 2. A FPGA is generally one kind of IC and the feature of FPGA is that a designer can build therein desired hardware circuits while using a PC and simple equipments. Thus, designers can realized their desired circuit on the FPGA after purchasing appropriate one on the market. They also can make a version up to the circuit for an end user even though they have installed it on a product.

FPGA (28) is commercially available by FPGA which is offered by Xilinx, Inc. (located in California, USA) or Altera Corporation (located in California, USA). Also, CPLD (Complex Programmable Logic Device) may be used instead of FPGA.

FPGA (28) includes an camera controller interface (IF) (30) in which receives an video signal from the camera module (12); a first conversion circuit (32) which converts the video signal from the camera controller IF (30) to a signal writable to an image memory (typically SDRAM) (76); a memory controller interface (IF) (52) which controls a read process from the image memory (76) and a write process therefrom; an image memory (76); a second conversion circuit (54) which converts the signal from the image memory (76) to a parallel image signal; a PATA controller interface (IF) (56); a CPU means (20) to control these factors; and memory (31) which provides an operation field and a store program field therein.

Typically, SDRAM (Synchronous DRAM), DDR, SDRAM (Double Data Rate SDRAM) can be used for the image memory (76).

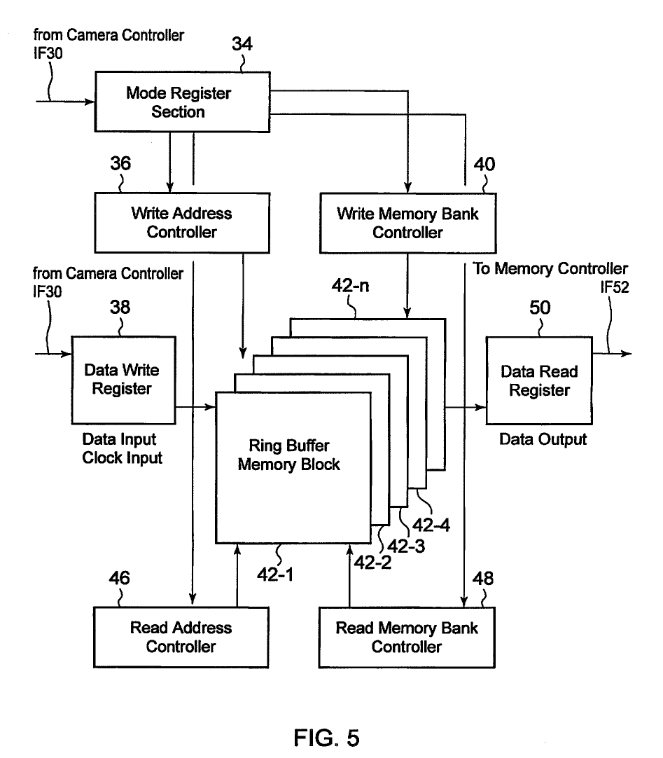

FIG. 5 explains the operation of first converter circuit (32) shown in FIG. 4. The first conversion circuit (32) utilizes a several coiled (i.e. ring-like) buffer memory block (42) to transfer continuous-streaming data (motion picture) to the image memory (76) and receives them therefrom (through the memory controller IF (52)). The number of buffers may be optionally decided as desired.

Under the control signal from the CPU (29), the mode register and ring buffer controller (34) select an action mode and send an action mode signal to the read memory bank controller (48). Also, the controller (34) decides the number of ring buffer and sends a control signal to the write address controller (40) to set up the number of buffer of coiled buffer memory block (42).

Image signal from camera controller IF (30) is temporary stored in data write register (38). Then, a image signal stored in data write register (38) is written over the oldest recorded buffer memory by time among several buffer memories (while referring to the index of record) under the control of write memory bank controller (40) and write address controller (36).

An image signal what is written in the coiled buffer memory block (42) is read in order and is written to the image memory (76) through the memory controller IF (52). In this time, loading from the buffer memory block (42) is from the oldest record to new buffer memory.

Any of the following several motion modes can be optionally employed.

In case of reading from the buffer memory faster than writing thereto during a reading mode, it does not read from buffer under writing mode and waits till finish writing after having read one before unfinished buffer memory. During a writing mode, start writing one by one after waiting for finish reading or skip a buffer under reading and write to a next buffer.

The second conversion circuit (54) is characterized in process of reading serial image data from image memory (76).

Motion data can be written to image memory (76) such as SDRAM or be read from it as described above.

### (PATA-Sata Conversion Circuit)

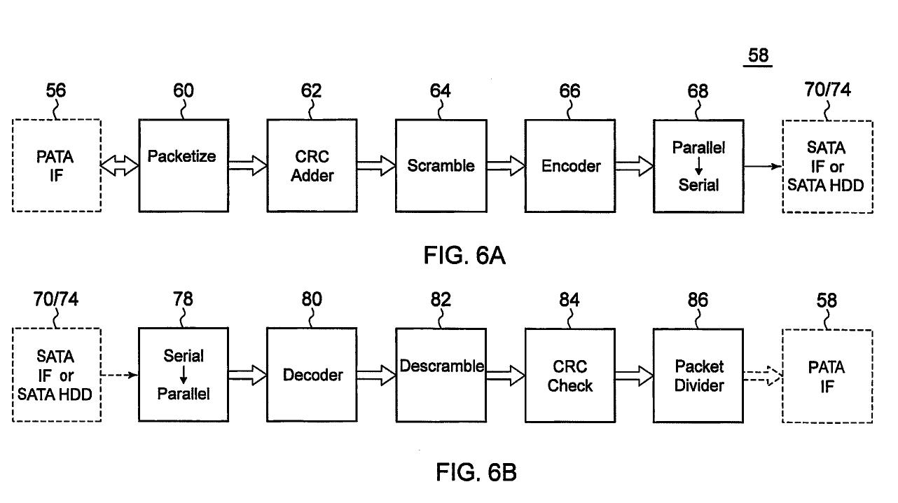

FIG. 6A is a block diagram showing an example of PATA-SATA convertor part of SATA camera system shown in FIG. 2. The PATA-SATA converter circuit (58) is a conversion circuit by which a parallel image signal output from the FPGA (28) under the operation of PATA (Parallel ATA, IDE) condition is converted to be able to transmit to the host SATA compatible PC (72) and/or HDD (74).

The PATA-SATA converter circuit (58) includes a packetize means (60), a CRC adder (62), a scramble means (64), an encoder (66) and a parallel-serial means (68).

ATA command, transfer image data and control signal information from the PATA-IF (56) be packetized at transport layer with the packetize means (60) to create FIS (Flame Information Structure), and is added CRC (Cyclic Redundancy Check) information thereto at link layer with the CRC adder (62), and is scrambled with the scramble means (64), and is made 8b/10b conversion to primitive with the encoder (66), and is converted to serial at physical layer by the parallel-serial means (68) to be sent to the SATA-IF (70) of the host PC (72) or/and the SATA HDD 74.

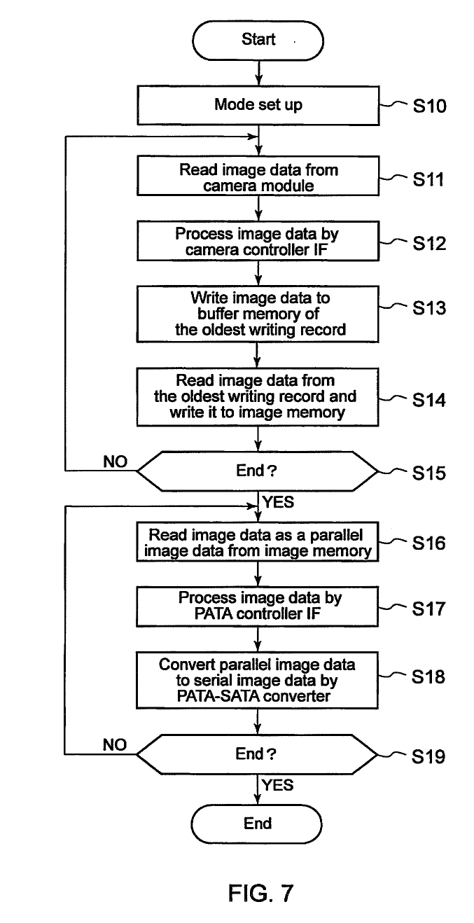

FIG. 7 shows the method for processing image data by way of the CPU (29) of the FPGA (28) when the SATA camera system (10) works as a host camera to the PC (72) or the SATA-HDD (74). The program of this method for processing image data is stored in the memory (31) in advance.

At step S10, each motion mode is set up under the control of CPU (29). For example, the number of ring-like buffers and the processing way in case of writing in the buffer memory faster than reading therefrom are decided.

At step S11, SATA camera IF (27) reads image data from the camera module (12).

At step S12, image data read from the camera module (12) is processed by the camera controller IF (30).

At step S13, image data is written to the buffer memory (42) of the oldest writing record one by one through the data register (38).

At step S14, image data is read from the oldest writing record of the buffer memory (42) and written it to the image memory (76) one by one.

At step S15, it is judged whether writing of image data from the camera module (12) to the image memory (76) has finished or not. If not finished yet, return to step S11.

At step S16, it is read as a parallel image data from the image memory (76).

At step S17, parallel image data read from the image memory (76) is processed by the PATA controller IF (56).

At step S18, parallel image data is converted to serial image data by the PATA-SATA converter (58).

At step S19, it is judged whether image data to be transferred from the image memory (76) to the PC (72) or the SATA-HDD (74) is finished or not. If image data remains yet, return to step S16. If the transfer of image data has finished, the processes terminates.

These processes are the method for processing image data executed by the CPU (29) of the SATA camera system (10).

### [Alternatives]

This embodiment of SATA camera system can adopt the following alternatives.

(1) The PATA-SATA converter (58) of the SATA camera system shown in FIG. 2 may also have the SATA-PATA converter (59) for reversely conversion. FIG. 6B is one example of block diagram of the SATA-PATA converter (59). The SATA-PATA conversion circuit (59) is a conversion circuit for connecting image signal output from the host PC (72) working under SATA condition and/or the SATA compatible HDD (74) to the FPGA (28) working under PATA condition (Parallel ATA, IDE condition).

As shown in FIG. 6B, the SATA-PATA conversion circuit (59) has the serial-parallel means (78), the decoder (80), the de-scramble means (82), the CRC check means (84) and the packet dividing means (86).

Serial image data (primitive information) from the SATA IF (70) of the PC (72) or the SATA compatible HDD (74) is changed to parallel at physical layer by way of the serial-parallel means (78), then is made 10b/8b conversion by the decoder (80), then released from scramble by the de-scramble (82), then CRC checked by way of the CRC check means (84) and converted to FIS, then divided to packets by way of the packet dividing means (86). Image data from the PC (72) or the SATA-HDD (74) is stored in the image memory (76) or a memory (not shown) of the camera module (12) of SATA-IF (27).

(2) This embodiment includes a computer program to control the writing of image signal from the SATA camera system (10) to the PC (72) or the SATA compatible HDD (74) or the reading of image signal from the PC (72) or the SATA compatible HDD (74).
(3) Further, this embodiment includes a recording media to record the computer programs.

### [Advantages or Effects of Sata Camera System]

Advantages or effects of the SATA camera system are as follows.

(1) The SATA camera system can directly transfer image data for motion picture at high-speed to a PC and a SATA compatible HDD etc. Also, it can directly take image data from a PC, a SATA compatible HDD to the SATA camera system.
(2) The SATA camera system can be directly connect to the host PC (72), the HDD (74) by adding the SATA camera IF (27) to the existing camera module (12), host PC (72), SATA compatible HDD (74) etc., without substantial changes to the existing camera module (12), and host PC (72), SATA compatible HDD (74) etc.
(3) SATA camera system can be changed between SATA device camera and SATA host camera by switching the stored program.

Accordingly, as a SATA device camera aspect, the SATA camera system (10) can be regarded as an external recording equipment from the host PC (72). Thus, under the control of the host PC (72), you can directly read image data stored in the image memory (76) of the SATA camera system to and write it to the PC (72).

Also, as a SATA host camera aspect; the SATA camera system (10) can use the SATA-HDD (74) as an external recording media under the control of CPU (29) without other computers. That is, the SATA camera system (10) can directly write image data to the HDD (74) or read image data therefrom.

(4) Moreover, if you employ the SATA camera system (10), under the control of CPU (29) of SATA camera system or the PC (72), you can write image data stored in the PC (72) or the SATA-HDD (74) by serial-parallel conversion.

### CONCLUSION

While the embodiments of the SATA camera system to the present invention have been described so far, these embodiments are described by way of example and it is needless to say that the present invention is not limited to those embodiments. The present invention may be added, varied and deleted by those skilled in the art.

For example, the SATA camera system (10) at FIG. 2, you can compose the camera module (12) and the SARA-IF (27) separately. That is, you can compose attachable SARA camera IF (27) to the camera module (12).

The scope of the present invention may be determined based on the scope of the appended claims.

1. A SATA camera system comprising,
a camera module, and
a SATA camera interface, wherein the SATA camera system is able to directly connect to a SATA compatible PC or a hard disk drive.

2. A SATA camera system according to claim 1, said SATA camera system comprising, at least,
a FPGA,
an image memory, and
a PATA-SATA converter; wherein
said FPGA processes the conversion of a digital image signal from camera module during writing and loading to the image memory,
said PATA-SATA converter converts the parallel image signal to a serial image signal to be able to send it to a SATA compatible PC or a HDD.

3. A SATA camera system according to claim 2,
said image memory is SDRAM or DDR SDRAM.

4. A SATA camera system according to claim 1, said FPGA including, at least,
a first converting circuit to convert digital image signal from said camera module to writable signal to image memory, and
a second converting circuit convert to read image signal written to said image memory as parallel image signal.

5. A SATA camera system according to claim 1, wherein
said camera system works as a SATA host camera, and the SATA host camera can used a SATA compatible HDD as an external recording media without other computers.

6. A SATA camera system according to claim 1, wherein
said SATA camera system works as a SATA device camera, and it can use as an outputting recording media for a main PC.

7. A SATA camera system according to claim 1, wherein
said SATA interface further has a SATA-PATA converter, thereby serial image data read from SATA compatible PC or HDD can be converted to parallel data to store to said image memory.

8. SATA camera interface means, wherein said means converts parallel image signal from camera module to serial image for connecting to a SATA compatible computer or HDD.

9. A SATA camera interface means according to claim 8, said interface means including, at least,
a FPGA,
an image memory, and
a PATA-SATA converter; wherein
said FPGA processes the conversion of a digital image signal from camera module during writing and loading to the image memory, and
said PATA-SATA converter converts the parallel image signal to a serial image signal to be able to send it to a SATA compatible PC or a HDD.

10. A SATA camera interface means according to claim 8, said FPGA including, at least,
a first converting circuit to convert digital image signal from said camera module to writable signal to image memory, and
a second converting circuit convert to read image signal written to said image memory as parallel image signal.

11. A SATA camera interface means according to claim 8,
said SATA interface further has a SATA-PATA converter, thereby serial image data read from SATA compatible PC or HDD can be converted to parallel data to store to said image memory.

12. A method for processing image data by SATA camera system, said method comprising the following steps of,
loading parallel imaging data from a camera module,
writing loaded image data to a buffer memory one by one followed by data,
loading image data from buffer memory followed by data and writing to image memory,
loading parallel data from image memory,
converting loaded parallel image data to serial image data by PATA-SATA converter, and
transferring serial data to PC or HDD.

13. A computer program, wherein said program orders a PC to execute each steps of claim 12.

14. A recording media, wherein said medium records therein the computer program of claim 13.
